(19) United States
(12) Patent Application Publication
(10) Pub. No.: US 2013/0215704 A1
(43) Pub. Date: Aug. 22, 2013

(54) Gas Mixer

(71) Applicant: Buerkert Werke GmbH, (US)

(72) Inventor: Johannes Eichert, Buettelborn (DE)

(73) Assignee: Buerkert Werke GmbH, Ingelfingen (DE)

(21) Appl. No.: 13/769,850

(22) Filed: Feb. 19, 2013

(30) Foreign Application Priority Data
Feb. 20, 2012 (DE) 102012003278.1

(51) Int. Cl. B01F 3/02

(52) U.S. Cl. CPC B01F 3/028
USPC 366/142; 366/160.5

(57) ABSTRACT

A gas mixer has at least two mass flow controllers which can control the gas mass flow rate of a gas line. A control unit is connected to the mass flow controllers to control the gas mass flow rate through each of the gas lines. Each mass flow controller has a volume counter, and the control unit is provided with a volume signal for each gas line. A method of controlling a gas mixer is provided in which a target value for the gas mass flow rate is predefined for a plurality of mass flow controllers each associated with a gas line. The ratio of the volumes that have flowed through the mass flow controllers up to now of the gases to be mixed are taken into account in determining the target values for the gas mass flow rate.

### TECHNICAL FIELD

The present invention relates to a gas mixer including at least two mass flow controllers which can control the gas mass flow rate of a gas line associated with the corresponding mass flow controller, and a control unit which is connected to the mass flow controllers to control the gas mass flow rate through each of the gas lines and thereby to adjust a desired gas mixture. The present invention also relates to a method of controlling a gas mixer in which, on the basis of a target value for the mixing ratio, a target value for the gas mass flow rate is predefined for a plurality of mass flow controllers which are each associated with a gas line through which a component of the gas mixture to be obtained flows.

### BACKGROUND OF THE INVENTION

Gas Mixers having two or more mass flow controllers and a control unit are known. Using such a gas mixer allows a desired gas mixture to be obtained in a fairly reliable manner in that the mass flow rate is controlled to the required value for each individual component of the gas mixture. When the gas mixer is operated continuously, it is thereby possible to obtain the gas mixture with a fairly high accuracy, this accuracy depending on the control accuracy of the mass flow controllers and on any measurement tolerances.

It has turned out, however, that in dynamic processes in which the gas mixer is required to provide only comparatively small volumes of the gas mixture and is therefore switched off again after a short operating period, the deviations in the composition of the gas mixture from the target value were larger than was to be expected.

The object of the invention resides in further developing a gas mixer of the type initially mentioned to the effect that a predefined mixing ratio of two or more components of a gas mixture is satisfied as precisely as possible in dynamic processes as well.

### SUMMARY OF THE INVENTION

A gas mixer includes at least two mass flow controllers which can control the gas mass flow rate of a gas line associated with the corresponding mass flow controller. The gas mixer further includes a control unit which is connected to the mass flow controllers to control the gas mass flow rate through each of the gas lines and thereby to adjust a desired gas mixture. Each mass flow controller has a volume counter associated therewith. The control unit is provided with a volume signal for each gas line.

A method of controlling a gas mixer is provided in which, on the basis of a target value for the mixing ratio, a target value for the gas mass flow rate is predefined for a plurality of mass flow controllers which are each associated with a gas line through which a component of the gas mixture to be obtained flows. The ratio of the volumes that have flowed through the mass flow controller up to now of the gases to be mixed is taken into account in determining the target values for the gas mass flow rate.

The invention is based on the finding that differences in the transient responses of the mass flow controllers are responsible for the deviations between the target value and the actual value of the composition of the gas mixture to be obtained. These differences result in that an occasionally appreciable deviation of the actual mass flow rate from the expected mass flow rate occurs in an initial phase of the control process. Over a longer operating period, the differences resulting therefrom between the theoretical quantity of a component of the gas mixture and the actually present quantity have no particular effect. In dynamic processes, on the other hand, in which the transient period of the controller takes up a significant part of the entire operating phase of the controller, the deviations may, however, be quite noticeable. According to the invention, this is countered in that a second controlled variable is introduced, more specifically the absolute mass flow rate (or volume flow rate) since the start of the respective control phase. In simplified terms, in this way the mass flow rate through the mass flow controller is corrected during an operating phase following the transient phase of the controller in such a manner to compensate for any deviations during the transient phase.

When gas quantities are measured, a distinction is made between their volumes and their masses. Since the gas quantity in a volume is dependent on the pressure and the temperature of the gas, it depends on the application which indication is decisive. Indications of quantity are therefore often standardized to standard conditions such as, e.g., 0° C./1013 mbar, and units of volume are then referred to as standard liters or normal liters. Within this meaning, the mass of the gas can also be converted to a (standard) volume. The terms “mass” and (standard) “volume” will therefore be used as synonyms below.

The mode of operation according to the invention of the gas mixer according to the invention can be illustrated with reference to a simplified example: Assume that a gas mixture of two components is to be provided, the two components having equal proportions. After the start of the gas mixer, the two mass flow controllers try to reach a predefined target value as quickly as possible. In this simple example, the two target values for the two mass flow controllers are identical. According to the invention, the overall mass flow rate through each of the gas lines is added up in parallel. If the control unit detects that the mass flow through one of the gas lines differs from the overall mass flow through the other gas line, the target value for the mass flow is corrected either for one of the mass flow controllers or for both of them at the same time such that the differences are compensated. For example, the mass flow through that gas line through which a lower volume has flowed can be temporarily increased, or the mass flow through the other gas line can be throttled. It is also possible to take both measures at the same time in order to balance the different mass flow rates more rapidly and thereby to adjust the desired gas mixture more rapidly.

According to a further configuration of the invention, the volume counter is integrated in the mass flow controller. In this way, in addition to a signal about the current flow rate, the mass flow controller can also provide the control unit with a signal about the volume that has flowed through as of a particular point in time.

Alternatively, the volume counter may be integrated in the control unit. This allows mass flow controllers to be used without change, which only provide a signal about the mass flow rate or volume flow rate. Based on this signal, the overall flow rate can then be integrated.

According to a variant, provision is made that the target values are modified subsequent to a transient phase. In this configuration, when the mass flow controllers are in a steady state, it is checked which differences between the target and actual values of the overall mass flow rate of the individual components of the gas mixture have arisen during the transient phase. These differences are subsequently compensated by the appropriate correction of the target values for the respective components.

Alternatively or additionally, it is possible to modify the target values in a switch-off phase. In this configuration, the mass flow rates that are still “let through” by the individual mass flow controllers as from a decision to switch the gas mixer off are dimensioned such that eventually the quantities of the individual components of the gas mixture that have flowed through the gas mixer are as exactly as possible such that the desired mixing ratio is reached. This design requires that up to the start of the compensation, only differences in volume have appeared that can be reasonably compensated during the switch-off phase of the gas mixer.

In any case a correction takes place automatically and continuously since the volume counter is generally in operation during operation of the controller, just like the correction of the target values. The correction effect is, however, noticeable to a more pronounced degree after each change of target values and overall flow rates.

Advantageous further configurations of the invention are apparent from the dependent claims.

These and other features may be best understood from the following drawings and specification.

### BRIEF DESCRIPTION OF THE DRAWINGS

The invention will now be described below with reference to an embodiment which is illustrated in the accompanying drawings, in which:

FIG. 1 schematically shows a gas mixer according to the invention;

FIG. 2 schematically shows a mass flow controller used in the gas mixer of FIG. 1;

FIG. 3 schematically shows the control unit used in the mass flow controller of FIG. 1;

FIG. 4 schematically shows a first diagram schematically showing the operation of a prior art gas mixer in the typical static operation with a constant target value;

FIG. 5 shows a second diagram schematically showing the operation of a prior art gas mixer in the typical intermittent operation; and

FIG. 6 shows a third diagram schematically showing the operation of a gas mixer according to the invention.

### DETAILED DESCRIPTION

FIG. 2 schematically shows a gas mixer which includes a first mass flow controller 1, a second mass flow controller 2, and a control unit 3. The first mass flow controller 1 is associated with a first gas line 4, and the second mass flow controller 2 is associated with a second gas line 5. Different gases, which together result in a gas mixture 6, flow through the two gas lines 4, 5, with the composition of the gas mixture being dependent on the mass fractions of the two components which flow through the gas lines 4, 5.

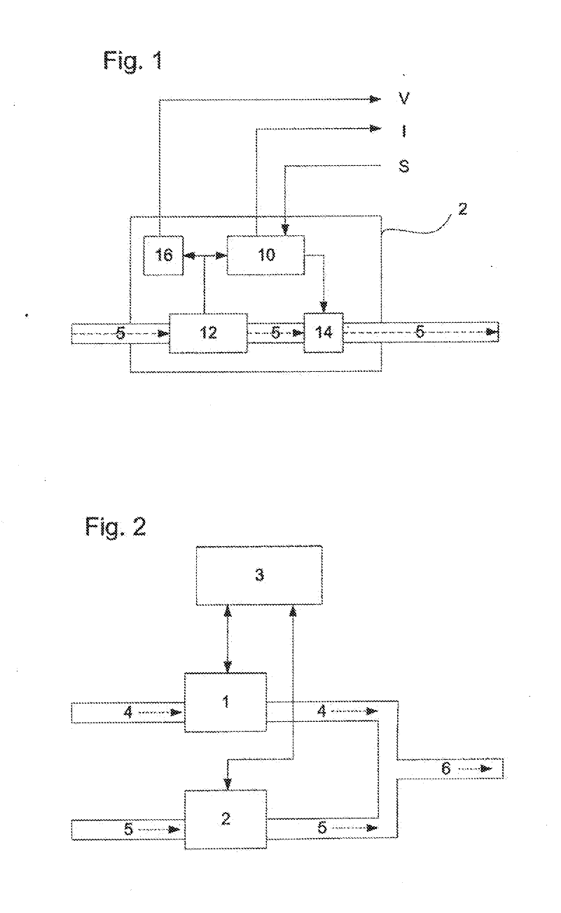

As shown in FIG. 1, each of the mass flow controllers 1, 2 includes a flow controller 10 which receives signals of a flow sensor 12 and acts on a control valve 14. The signal of the flow sensor 12 is also transmitted to a volume counter 16.

Although reference is made here somewhat vaguely to a “volume counter”, it is clear that, in the final analysis, gas mass flow rates are compared with one another. Assuming that the two gases to be mixed have the same pressure and the same temperature, volumes can also be mixed or put into a relation to one another. When a standardized volume is measured, a correct mixture is independent of pressure and temperature.

The mass flow controller provides to the control unit 3 a volume signal V and an actual signal I for the measured flow rate and receives from the control unit a target value S for the flow rate.

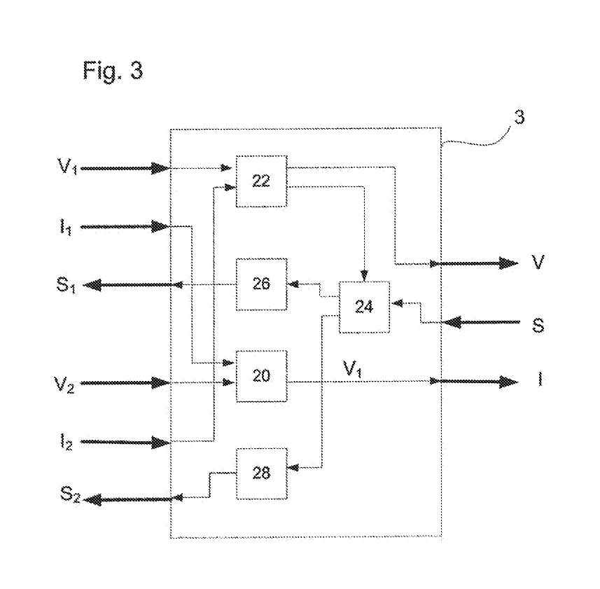

The control unit 3 (see FIG. 3) receives the signals V and I from the mass flow controllers 1, 2 and sends the corresponding target value to the flow controller 10. The actual values of the mass flow rate are made available by an assembly 20 for calculating the flow rate-related mixing ratio. The values of the volume counter are made available to an assembly 22 for calculating the volume-related mixing ratio. The latter is connected with an assembly 24 for calculating a correction value, which additionally receives the target value S for the mixing ratio. The assembly 24 calculates a correction value which is made available to an assembly 26 for the calculation of the target value for the flow rate of the mass flow controller 1, and a correction value which is made available to an assembly 28 for the calculation of the target value for the flow rate of the mass flow controller 2. The corresponding target values S₁ and S₂, respectively, are then transmitted to them.

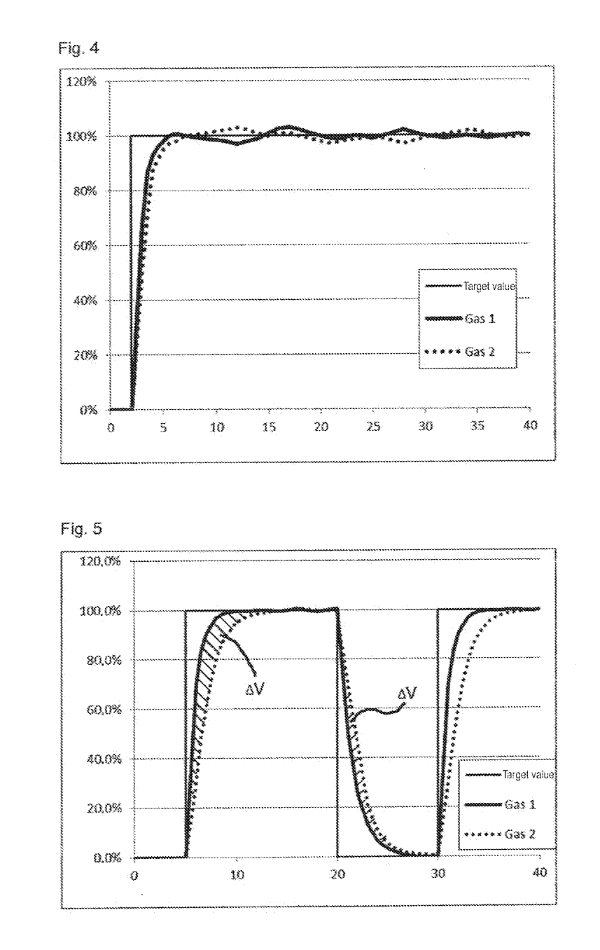

In FIG. 4, the profile of a target value of the mixing ratio and the actual mass flow rate or volume flow rate, standardized to 100%, are plotted. It can be seen that after a certain transient period, the target value for the two components is satisfied fairly reliably.

FIG. 5 shows the gas flow rates for a dynamic operation of a gas mixer, that is, for operating phases that are relatively short and in which the transient of the mass flow controllers accounts for a considerable part of the overall operating period. It is apparent here that the flow rate in the gas line 4, to which the mass flow controller 1 is assigned, heads for the target value very much faster than is the case for the mass flow controller 2 of the gas line 5. This results in a difference in the overall mass flow rate of the components of the gas mixture, as measured from the start of the respective operating phase (here point in time T₀) and a point in time at which the second mass flow rate also reaches the target value (here point in time T₁). The resultant differential volume ΔV is drawn in hatched.

The switch-off also leads to a differential volume AV since the mass flow controller 2 is “slower” than the mass flow controller 1 and, therefore, the mass flow rate heads for the target value more slowly. Thereby, the mass flow controller 2 can make up for part of the differential volume ΔV which it has “lost” upon the switch-on. This, however, is a random and non-controlled process.

According to the invention, provision is made that based on the difference in the absolute flow rates as ascertained in the control unit 3 (whether mass-related or volume-related), the correction value is determined by which this difference is balanced during further operation of the gas mixer, so as to altogether obtain the predefined gas mixture as precisely as possible.

If the gas mixer were to be operated constantly over a longer period of time, the correction value could be translated such that the mass flow controller for the gas component 2 permits a greater flow rate over a specific period of time, so that eventually the same gas quantity is contributed for the gas mixture.

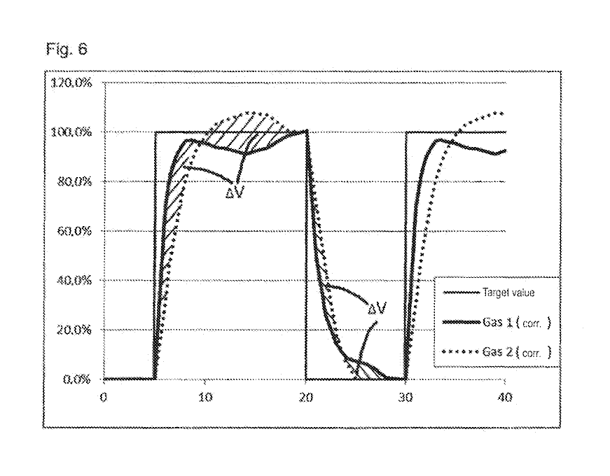

FIG. 6 shows a diagram showing the operation of the mass flow controller according to the invention. Based on the signals of the volume counters, the control unit 3 detects that the volume flow rate of the mass flow controller 2 is lower than that of the mass flow controller 1. Therefore, a correction value is calculated, so that the target value for the mass flow controller 2 is raised and the one for the mass flow controller 1 is lowered (see the period of time as of t=10 sec.). The differential volumes AV are thereby balanced.

The same thing happens upon switch-off. On the basis of the signals of the volume counters, the control unit will intervene as of a specific point and force a “follow-up run” of the mass flow controller 1 (see the sharp bend in the curve at t=23 sec.), so that here, too, the differential volumes AV are balanced.

Although the exemplary embodiment described is a gas mixer including two mass flow controllers, which mixes a gas mixture made up of two components, it is obvious that more than two mass flow controllers can also be used for producing a gas mixture made up of more than two components.

The control unit 3 described here is, as a rule, incorporated in the control unit of a machine and receives its target values from the same. This specification is effected by means of digital signals via field bus, for example, CAN bus or field bus. Alternatively, analog input signals may be used. It is also possible to set the specifications directly at the control unit, for example by a user interface such as a keypad or a touch display.

The communication between the control unit 3 and the mass flow controllers 1, 2 is effected via digital signals (for example, RS232 or RS485 or also CAN bus). The control unit 3 includes a plurality of functions here: Firstly, there is the signal conversion to target values for the individual mass flow controllers. These are then controlled in an autarkic manner by the mass flow controllers. Furthermore, there is effected a continuous monitoring of the flow rates and volumes that flow through the mass flow controllers, as well as a comparison with the desired target values. Finally, in the event of deviations of the volumes, the internal target values to the mass flow controllers are corrected to obtain the desired mixing ratios.

The above-described gas mixer is especially suitable for all applications in which a correct volume balancing is important. But it offers particular advantages in processes which make very high requirements, for example when a gas mixture is needed intermittently. Examples of this include modified atmosphere packagings for food, which are filled with a gas mixture within a short time. These applications also require the control of a mixing ratio related to the gas volume.

Although an embodiment of this invention has been disclosed, a worker of ordinary skill in this art would recognize that certain modifications would come within the scope of this invention. For that reason, the following claims should be studied to determine the true scope and content of this invention.

1. A gas mixer comprising:
at least two mass flow controllers which can control a gas mass flow rate of a gas line associated with the corresponding mass flow controller; and
a control unit connected to the mass flow controllers to control a gas mass flow rate through each of the gas lines and thereby to adjust a desired gas mixture, wherein each mass flow controller has a volume counter associated therewith and wherein the control unit is provided with a volume signal for each gas line.

2. The gas mixer according to claim 1, wherein the volume counter is integrated in the mass flow controller.

3. The gas mixer according to claim 1, wherein the volume counter is integrated in the control unit.

4. A method of controlling a gas mixer, in which, on the basis of a target value for a mixing ratio, a target value for a gas mass flow rate is predefined for a plurality of mass flow controllers which are each associated with a gas line through which a component of the gas mixture to be obtained flows, wherein the ratio of volumes that have flowed through the mass flow controllers up to now of the gases to be mixed is taken into account in determining target values for the gas mass flow rate.

5. The method according to claim 4, wherein the target values are modified subsequent to a transient phase.

6. The method according to claim 4, wherein the target values are modified in a switch-off phase.
